(19) United States
(12) Patent Application Publication
(10) Pub. No.: US 2011/0176588 A1
(43) Pub. Date: Jul. 21, 2011

(54) METHOD AND DEVICE FOR DATA PROCESSING AND COMMUNICATION SYSTEM COMPRISING SUCH DEVICE

(75) Inventors: Thomas Ahrndt, Ottobrunn (DE); Dietmar Gernegross, Oberhaching (DE)

(73) Assignee: NOKIA SIEMENS NETWORKS OY, Espoo (FI)

(21) Appl. No.: 13/120,708

(22) PCT Filed: Sep. 24, 2009
(86) PCT No.: PCT/EP2009/062369

§ 371 Date: Mar. 24, 2011

(30) Foreign Application Priority Data
Sep. 24, 2008 (EP) 08105423.1

(51) Int. Cl. H04L 5/16

(52) U.S. Cl. 375/222

(57) ABSTRACT

A method and a device for data processing are provided, wherein a first network element conveys data towards a second network element at least one frequency at, e.g., a precalculated reduced transmission power to feign signal-to-noise ratio. Furthermore, a communication system is suggested comprising said device.

The invention relates to a method and to a device for data processing and to a communication system comprising such a device.

DSL or xDSL, is a family of technologies, comprising in particular ADSL, ADSL2, ADSL2+, VDSL, VDSL2, that provide digital data transmission over the wires of a local telephone network.

Asymmetric Digital Subscriber Line (ADSL) is a form of DSL, a data communications technology that enables faster data transmission over copper telephone lines than a conventional voice band modem can provide. Such fast transmission is achieved by utilizing frequencies that are normally not used by a voice telephone call, in particular, frequencies higher than normal human hearing.

VDSL (Very High Speed DSL) is an xDSL technology providing faster data transmission over a single twisted pair of wires. High bit rates are achieved at a range of about 300 meters (1000 ft), which allows for 26 Mbit/s with symmetric access or up to 52 Mbit/s in downstream-12 Mbit/s in upstream with asymmetric access.

According to its high bandwidth, VDSL is capable of supporting applications like HDTV, as well as telephone services (e.g., Voice over IP) and general Internet access, over a single connection.

VDSL2 (Very High Speed Digital Subscriber Line 2) is an access technology that exploits the existing infrastructure of copper wires that were originally used for plain old telephone service (POTS). It can be deployed from central offices (Cos), from fiber-fed cabinets preferably located near the customer premises, or within buildings.

ITU-T G.993.2 (VDSL2) is an enhancement to G.993.1 (VDSL) that permits the transmission of asymmetric and symmetric (full duplex) aggregate data rates up to 200 Mbit/s on twisted pairs using a bandwidth up to 30 MHz.

The xDSL wide band modulation approaches are susceptible regarding crosstalk interference that is introduced to the twisted pair transmission line and received by the modem.

Crosstalk occurs when wires are coupled, in particular between wire pairs of the same or a nearby bundle that are used for different signal transmission. Hence, data signals from one or more sources can be superimposed on and contaminate a data signal. The crosstalk comprises a near-end crosstalk (NEXT) and a far-end crosstalk (FEXT).

Based on such crosstalk, data signals transmitted over twisted-pair lines can be considerably degraded by the crosstalk interference generated on one or more adjacent twisted-pair phone line in the same and/or a nearby multi-core cable or bundle. With an increasing transmission speed, this situation even deteriorates, which may significantly limit a maximum data rate to be transmitted via a single line.

Furthermore, idle data sent induce crosstalk interference and hence disturb user data sent via other lines of, e.g., a multi-core cable. As there are typically 50 lines within one multi-core cable, such crosstalk could significantly impair the overall performance of the transmitting capability.

xDSL in particular utilizes Discrete Multi-Tone (DMT) modulation. The signal to be transmitted is obtained by an Inverse Fourier Transform of the frequency signal, which is constituted from a set of QAM symbols to be transmitted. Each so called DMT symbol may comprise of a plurality of QAM symbol which are organized as subcarriers of a width of 4,3125 kHz or 8,625 kHz.

A noise interference on each line (xDSL) varies with a number of currently active DSL users. Thus, due to the dynamic of the DSL users, crosstalk between individual DSL lines is always a snapshot.

Whenever a DSL (e.g., ADSL or VDSL) is activated, loop conditions are measured during a training phase. The training reveals a Quiet Line Noise per sub-carrier (QLNps) at the receiver input. It allows calculating a Signal-to-Noise Ratio (SNRps) for each sub-carrier. Due to the snapshot scenario, changing loop conditions and noise interference are taken into account by providing a margin as a reserve for calculating the bits. Said margin can be loaded on each sub-carrier.

This margin is normally a flat margin, i.e. a given value for all sub-carriers based on the disturbing noise during the training phase.

However, in real life crosstalk varies also over frequency as well as over time. It also depends on an actual DSL technology or loop topology. Due to real crosstalk induced by other lines (xDSL), a re-training may become necessary for each (heavily) disturbed line. Triggering of such re-training depends on the size of said margin. Also, re-training interrupts data traffic which is perceived on higher layers. Such interruptions need to be avoided.

The problem to be solved is to overcome the disadvantages stated above and in particular to improve the data processing over xDSL by significantly reducing the risk for re-training due to interference and/or crosstalk without spending a high flat margin and therefore loosing performance.

This problem is solved according to the features of the independent claims. Further embodiments result from the depending claims.

In order to overcome this problem, a method is provided for data processing wherein a first network element conveys data towards a second network element at least one frequency at a reduced transmission power.

Said reduced transmission power can be predetermined, configured or calculated (e.g., in real-time). The transmission power may, e.g., be calculated based on transmission values that could be obtained by a previous training phase. It is also an option that said transmission power is determined for all, a group of or particular frequencies.

Advantageously, the second network element (e.g., a user device or a Customer Premises Equipment) does not have to be informed about such reduced transmission power. As an option, the second network element may be informed by a message or notification, e.g., via a separate overhead channel, about the reduced transmission power.

The transmission power used for the data conveyed via said at least one frequency is reduced compared to a nominal or reported transmission power (feigned) of at least one other frequency.

Hence, instead of adding noise to the at least one frequency, the transmission power is reduced thereby allowing the second network element a standard processing based on the attenuated signal received.

Advantageously the second network element is not aware of the fact that the first network element reduces the transmission power and hence such information is not provided via any kind of signaling (in-band or out-band). As an alternative, such information may be provided to the second network element and it may further be detected and thus considered to be discarded by the second network element, i.e., the second network element may deliberately adjust to the signal (as if it were not attenuated) to increase its margin for heavily disturbed signals or high interference scenarios.

In an embodiment, said data processing is a DMT data processing via at least one digital subscriber line.

In particular, various kinds of digital subscriber lines (“xDSL”) can be utilized with the approach provided herein.

In another embodiment, the first network element is or is associated with a Digital Subscriber Line Access Multiplexer and/or a Central Office.

In a further embodiment, the second network element is or is associated with a Customer Premises Equipment, in particular a digital subscriber line modem.

The second network element may in particular deployed with, near or at a customer's premises.

In a next embodiment, the second network element determines a signal-to-noise ratio (SNR) based on the data conveyed.

Such data may comprise signals that are processed at the second network element in order to determine the SNR.

It is also an embodiment that the first network element adds noise to data to be conveyed for at least one frequency.

In addition to reducing the transmission power, the first network element may also add noise to the at least one frequency.

Pursuant to another embodiment, the data is conveyed towards the second network element during a startup-phase and/or during a training-phase of the second network element.

Such startup-phase comprises a training of a modem at or being associated with the second network element.

According to an embodiment, the first network element coordinates several startup-phases and/or training-phases with several second network elements.

Hence, the first network element can utilize and/or assign (indirectly) frequencies to lower transmission rates for several trainings of several modems. The first network element may in particular utilize such startup-phases and/or training-phases according to lines that interfere with each other, in particular lines of a single cable binder.

The problem stated above is also solved by a device comprising a and/or being associated with a processor unit and/or a hard-wired circuit and/or a logic device that is arranged such that the method as described herein is executable on said processor unit.

According to an embodiment, the device is a communication device, in particular a or being associated with a central office or digital subscriber line access multiplexer.

The problem stated supra is further solved by a communication system comprising the device as described herein.

Embodiments of the invention are shown and illustrated in the following FIGURE:

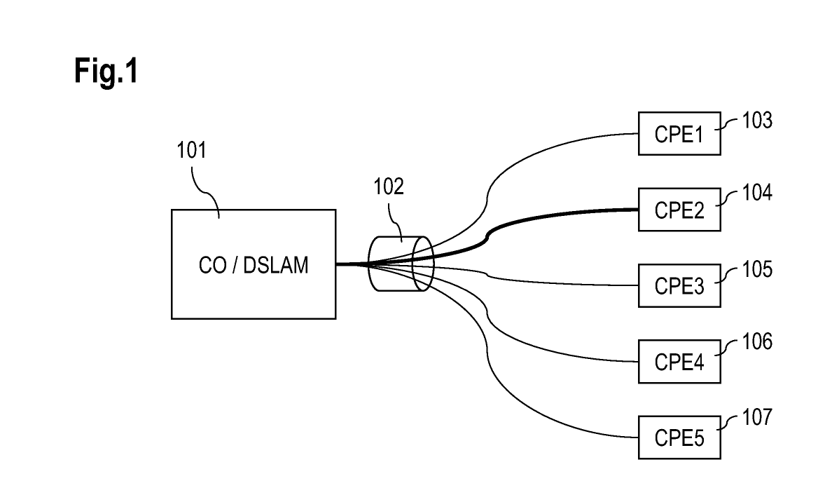

FIG. 1 shows a diagram comprising a CO and/or a DSLAM that is connected via a cable binder to several CPEs.

The approach provided herein in particular changes a Signal-to-Noise Ratio (SNR) condition for a Customer Premises Equipment (CPE). Advantageously, this can be done without any necessity of adding noise to a line.

The SNR condition for a CPE can be modified by changing a transmit signal level.

According to the fact that SNR is based on a receive signal level (S) related to the noise (N) level, increasing the noise level (N) or reducing the transmit signal level (decreasing transmit signal and as result decreasing receive signal S level) both influence the SNR in the same direction.

Advantageously, the CPE may perform standard SNR estimation by calculation of a received SNR. The actual transmit power cannot be measured by the CPE. Instead, it may be reported during a training phase or an overhead channel may be provided and a Digital Subscriber Line Access Multiplexer (DSLAM) or a Central Office (CO) may inform the CPE about the actual transmit level via such overhead channel.

Thus, if the DSLAM or CO conveys signals towards the CPE at a lower transmit power at particular frequencies without informing the CPE about such reduced transmission power, the SNR calculation at the CPE is based on the reduced (not nominal or reported) transmit power and the resulting SNR can be compared to a SNR as if it were based on real noise generated and conveyed over the line. However, the real-time constraints for the approach reducing the transmit power at the DSLAM or CO and not informing the CPE are significantly lower than in the scenario of adding noise to the line.

It is noted that the CPE may be informed of the reduced transmission power by the DSLAM or the CO, but it may be also be informed about or decide to discard this information and in particular to adjust to the signal conveyed by the DSLAM as if it were not a signal of reduced power. Hence, the CPE may deliberately utilize such signal of reduced power to implement a safety-margin in particular during training or startup.

FIG. 1 shows a diagram comprising a CO and/or DSLAM 101 that is connected via a cable binder 102 to several CPEs 103 to 107.

As an example, during a training phase of CPE2 104, CO/DSLAM 101 reduces the transmitting power of data to be conveyed towards CPE2 104. Such data is preferably conveyed via digital multi-tone modulation utilizing at least one frequency or at least one band. The CPE2 104 adjusts to this signal of reduced transmission power. In case adjacent lines convey normal traffic, CPE2 104 adjusts its (highest) possible data rate according to the inference resulting from adjacent lines based on the reduced transmission power provided by the CO/DSLAM 101.

Thus, during training the CPE2 104 maintains a safety margin due to the reduced transmission power set forth by the CO/DSLAM 101 to cope with a higher degree of interference during Showtime (compared to the interference that occurred during the training phase). For example, the approach allows the CPE during training to adjust to a data rate that it can maintain even in situations of higher interference. Advantageously, the error rate can be significantly reduced during such situation of high interference and re-training can efficiently be avoided.

### List of Abbreviations:

### CO Central Office

### CPE Customer Premises Equipment

### DMT Discrete Multi-Tone

### DSL Digital Subscriber Line

### DSLAM DSL Access Multiplexer

### IFT Inverse Fourier Transform

### OFDM Orthogonal Frequency Division Multiplexing

### QAM Quadrature Amplitude Modulation

SNR Signal-to-Noise Ratio

1-12. (canceled)

13. A method for data processing, which comprises the steps of:
during a training-phase of customer premises equipment, reporting via a central office a transmit power to the customer premises equipment;
conveying, via the central office, data towards the customer premises equipment with a reduced transmission power compared to a reported transmission power at least one frequency; and
determining via the customer premises equipment a signal-to-noise ratio based on the data conveyed.

14. The method according to claim 13, which further comprises informing the customer premises equipment about a reduced transmission power.

15. The method according to claim 13, which further comprises performing the data processing via DMT data processing with at least one digital subscriber line.

16. The method according to claim 13, which further comprises forming the central office as a Digital Subscriber Line Access Multiplexer.

17. The method according to claim 13, wherein the customer premises equipment is a digital subscriber line modem.

18. The method according to claim 13, which further comprises adding, via the central office, noise to the data to be conveyed for at least one frequency.

19. The method according to claim 13, which further comprises conveying the data towards the customer premises equipment during a startup-phase of the customer premises equipment.

20. The method according to claim 20, wherein the central office coordinates several startup-phases and/or training-phases with several customer premises equipments.

21. The method according to claim 13, which further comprises informing the customer premises equipment about a reduced transmission power via an overhead channel.

22. The method according to claim 13, wherein the central office is associated with a Digital Subscriber Line Access Multiplexer.

23. The method according to claim 13, wherein the customer premises equipment is associated with a digital subscriber line modem.

24. A device, comprising:
an apparatus programmed to:
during a training-phase of customer premises equipment, report via a central office a transmit power to the customer premises equipment;
convey, via the central office, data towards the customer premises equipment with a reduced transmission power compared to a reported transmission power at least one frequency; and
determine via the customer premises equipment a signal-to-noise ratio based on the data conveyed.

25. The device according to claim 24, wherein the device is a communication device.

26. The device according to claim 25, wherein the device is a selected from the group consisting of a central office and a digital subscriber line access multiplexer.

27. The device according to claim 24, wherein said apparatus is selected from the group consisting of a processor unit, a hard-wired circuit and a logic device.

28. A communication system, comprising:
a device programmed to:
during a training-phase of customer premises equipment, report via a central office a transmit power to the customer premises equipment;
convey, via the central office, data towards the customer premises equipment with a reduced transmission power compared to a reported transmission power at least one frequency; and
determine via the customer premises equipment a signal-to-noise ratio based on the data conveyed.
